(19) United States
(12) Patent Application Publication
(10) Pub. No.: US 2007/0070599 A1
(43) Pub. Date: Mar. 29, 2007

(54) Portable computer

(75) Inventor: Keng-Ming Chang, Tu-Cheng (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI Precision Industry CO., LTD., Tu-Cheng City (TW)

(21) Appl. No.: 11/440,293

(22) Filed: May 24, 2006

(30) Foreign Application Priority Data
Sep. 23, 2005 (CN) 200510037499.4

(51) Int. Cl. G06F 1/20

(52) U.S. Cl. 361/687

(57) ABSTRACT

A portable computer (100) includes a main body (200), a cover (300) and a thermally conductive hinge (400). The main body has at least one heat generating device (210) and a heat conductor (230) having a first end (231) thermally coupled to the at least one heat generating device and an opposite second end (232). The cover has a cover heat dissipating module (320). The thermally conductive hinge rotatably couples the cover to the main body, and the thermally conductive hinge includes an inner axle (410) coupled to the cover and an outer tube (420) coupled to the main body and receiving the inner axle therein. The inner axle is in thermal contact with the outer tube and thermally coupled to the cover heat dissipating module, and the outer tube is thermally coupled to the second end of the heat conductor.

### BACKGROUND

1. Field of the Invention

The present invention relates to portable computers, and more particularly, to a portable computer with excellent thermal dissipation.

2. Discussion of the Related Art

Portable (e.g. notebook or laptop) computers have many advantages, such as light weight, small volume, and excellent mobility. At the same time, the processing power of portable computers continues to increase. Because of heat produced by microprocessors, disk drives, power supplies and other components increases with increased processing power, challenges exist for computer manufacturers regarding dissipation of heat from portable computers. The thermal ceiling for portable computers is now being reached. Adding large passive heat sinks and/or active cooling devices, such as fan/heatsink combinations to dissipate heat defeats the goals of a small, light, thin computer with a long-life battery. In addition, controlling temperature is also important for proper functionality, reliability and human comfort.

Referring to FIGS. 4 and 5, a conventional portable computer 10 includes a main body 20, a cover 30 and a hinge 40 attached to the main body 20 and the cover 30 for permitting the cover 30 to be movable between an open position and a closed position. The main body 20 includes at least one heat generating device 21, such as microprocessors, and a first heat conductive block 23. The heat generating device 21 and the first heat conductive block 23 are connected by a first heat pipe 22. The cover 30 includes a heat dissipating module 32 and a second heat conductive block 31. The heat dissipating module 32 and the second heat conductive block 31 are connected by a second heat pipe 33. The conventional portable computer 10 further includes at least one braided wire 50 connecting the first heat conductive block 23 of the main body 20 and the second heat conductive block 31 of the cover 30.

The braided wire 50 is flexible and made from copper, or other metals having a thermal conductivity at least as high as copper. The braided wire 50 can quickly conduct heat generated from the heat generating device 21 of the main body 20 into the heat dissipating module 32 of the cover 30. However, because the braided wire 50 is used, a certain space in the portable computer 10 is needed to contain the braided wire 50, thus the design of the portable computer 10 is made complicated and the assembly is more difficult. Furthermore, the braided wire 50 is flexible, and when the portable computer 10 is used, the braided wire 50 must be bent. Thus after using a time, the braided wire 50 will be change shape and even be damaged so as to influence the thermal properties of the portable computer 10.

What is needed, therefore, is a portable computer with excellent thermal property and simple structure.

### SUMMARY OF THE INVENTION

A portable computer with excellent thermal property according to one preferred embodiment includes a main body, a cover and a thermally conductive hinge. The main body has at least one heat generating device and a heat conductor having a first end thermally coupled to the at least one heat generating device and an opposite second end. The cover has a cover heat dissipating module. The thermally conductive hinge rotatably couples the cover to the main body. The thermally conductive hinge includes an inner axle coupled to the cover and an outer tube coupled to the main body and receiving the inner axle therein. The inner axle is in thermal contact with the outer tube and is thermally coupled to the cover heat dissipating module. The outer tube is thermally coupled to the second end of the heat conductor.

Compared with conventional portable computer, the present portable computer enjoys several advantages. The present portable computer only uses the thermally conductive hinge rotatably coupling the cover and the main body for permitting the cover to be movable relative to the main body, so the present portable computer has a simple configuration and may be assembled easily. Furthermore, the thermally conductive hinge can quickly conduct heat generated from the heat generating device to the cover heat dissipating module of the cover, thus the heat can be dissipated quickly. The present portable computer has excellent thermal properties.

Other advantages and novel features will become more apparent from the following detailed description of the present portable computer, when taken in conjunction with the accompanying drawings.

### BRIEF DESCRIPTION OF THE DRAWINGS

Many aspects of the present portable computer can be better understood with reference to the following drawings. The components in the drawings are not necessarily to scale, the emphasis instead being placed upon clearly illustrating the principles of the present portable computer. Moreover, in the drawings, like reference numerals designate corresponding parts throughout the several views.

FIG. 1 is an exploded, isometric view of a portable computer in accordance with a preferred embodiment;

FIG. 2 is a schematic, cross-sectional view of a cover of FIG. 1;

FIG. 3 is a schematic, cross-sectional view of a thermally conductive hinge of FIG. 1;

FIG. 4 is an exploded, isometric view of a conventional portable computer; and

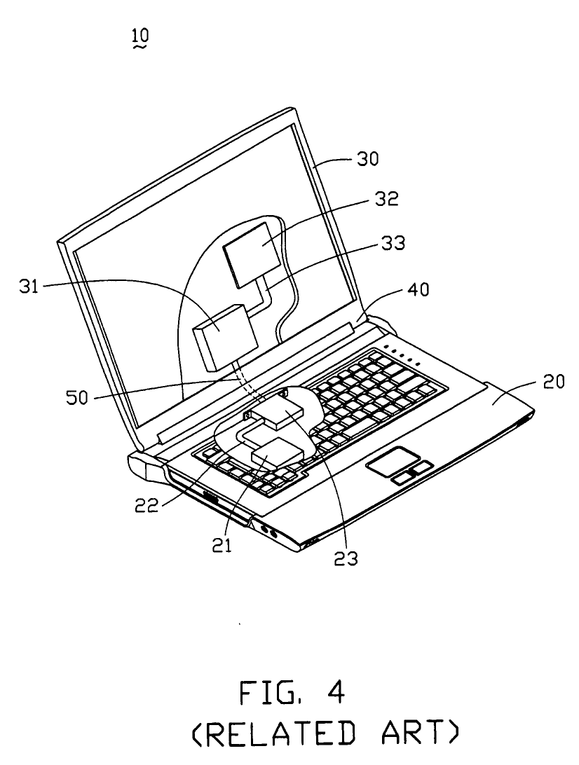

FIG. 5 is a schematic, part-enlarged view of FIG. 4.

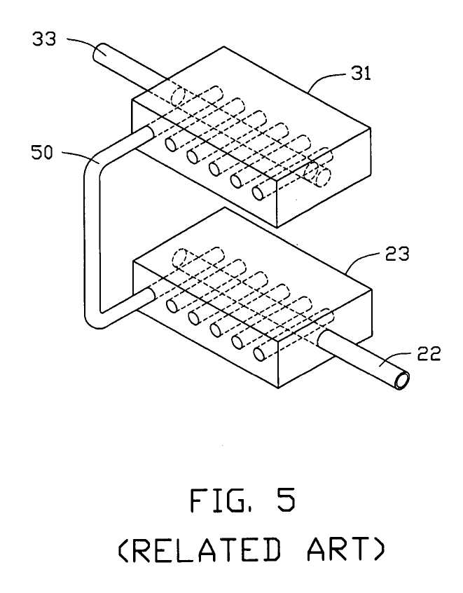

### DETAILED DESCRIPTION OF PREFERRED EMBODIMENT

Reference will now be made to the drawings to describe a preferred embodiment of the present portable computer with excellent thermal property in detail.

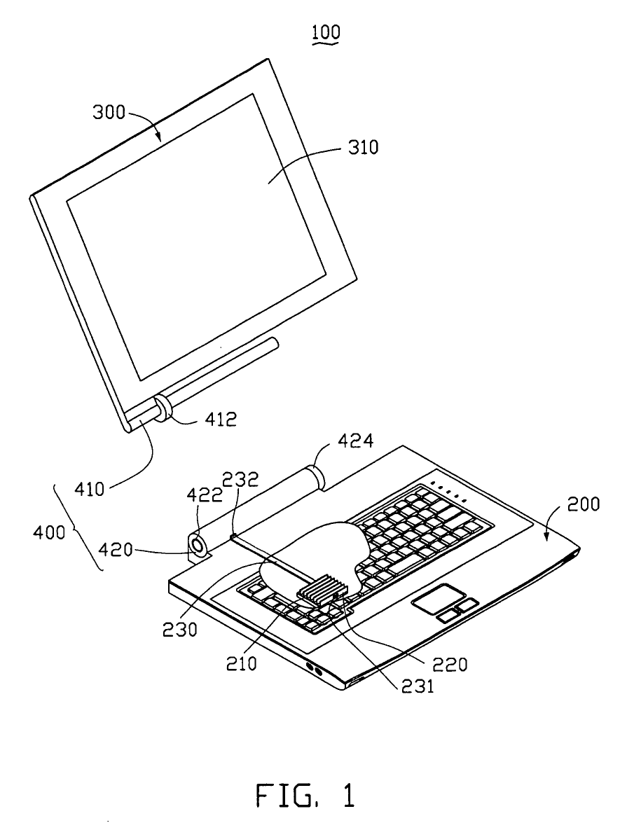

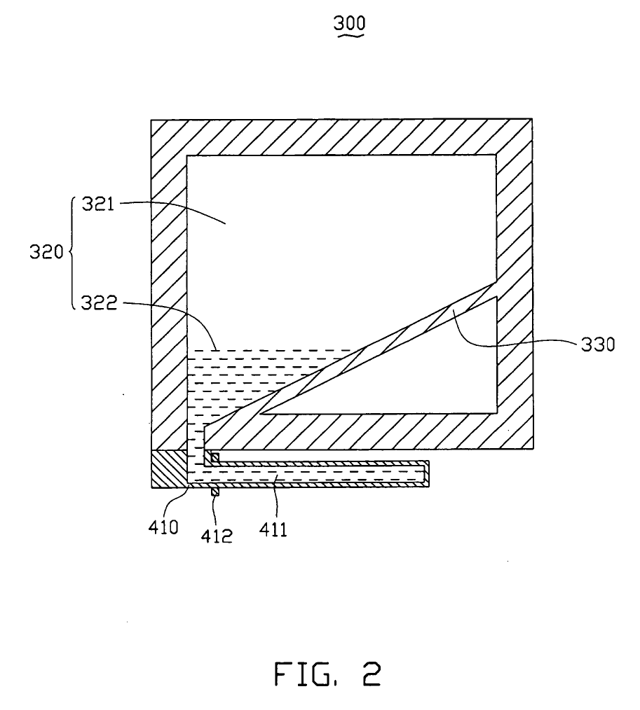

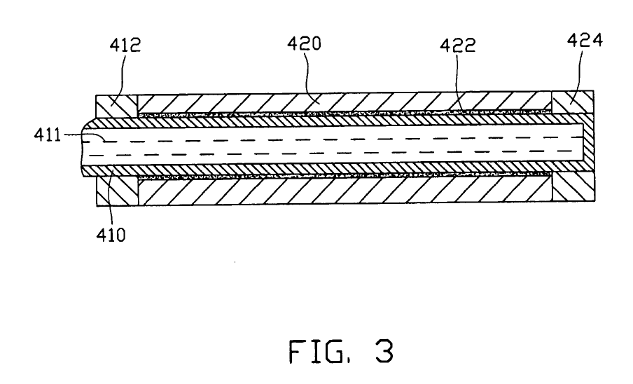

Referring to FIGS. 1 to 3, a portable computer 100 with excellent thermal property in accordance with a preferred embodiment is shown. The portable computer 100 includes a main body 200, a cover 300 and a thermally conductive hinge 400 rotatably coupling the cover 300 to the main body 200 for permitting the cover 300 to be movable relative to the main body 200 between an open position and an closed position.

The main body 200 includes at least one heat generating device 210, a main body heat dissipating module 220 and a heat conductor 230. The heat generating device 210 may be a microprocessor. The main body heat dissipating module 220 may be a heat sink and is arranged on the heat source 210 for dissipating the heat generated from the heat source 210. The heat conductor 230 may be a heat pipe and has a first end 231 thermally coupled to the at least one heat generating device 210 and an opposite second end 232 extending to the thermally conductive hinge 400.

The cover 300 mainly includes a display screen 310 and a cover heat dissipating module 320 arranged behind the display screen 310. The display screen 310 is arranged an inner side of the cover 300 facing to the main body 200. The cover heat dissipating module 320 is arranged at a corresponding opposite side of the cover 300 and behind the display screen 310. In the present embodiment, the cover heat dissipating module 320 includes a chamber 321 and a working fluid 322 received therein. The cover heat dissipating module 320 is similar to a heat pipe, which can dissipate heat quickly.

The hinge 400 is a thermally conductive hinge. The hinge 400 includes an inner axle 410 and an outer tube 420. The inner axle 410 is coupled to the cover 300, and the outer tube 420 is coupled to the main body 200. The inner axle 410 is in thermal contact with the outer tube 420 and is thermally coupled to the cover heat dissipating module 320. The outer tube 420 is thermally coupled to the second end 232 of the heat conductor 230. The inner axle 410 and the outer tube 420 can be engaged so that the cover 300 is mounted on the main body 200 and can be movable relative to the main body 200 between the open position and the closed position. As the hinge 400 is the thermally conductive hinge, the inner axle 410 and the outer tube 420 are also thermal conductive components. In the present embodiment, the inner axle 410 is a hollow axle with a working fluid contained therein.

The inner axle 410 is extended from the cover 300 and thermally coupled to the chamber 321 the cover heat dissipating module 320. The working fluid 322 in the chamber 321 may flow into the inner axle 410, and the working fluid 411 in the inner axle 410 may also flow into the chamber 321. The cover heat dissipating module 320 further includes a clapboard 330 arranged in the chamber 321 configured for leading the working fluid 322 into the inner axle 410.

The outer tube 420 is a hollow tube. The outer tube 420 is coupled to the main body 200 and connected with the main body heat dissipating module 220 by the heat conductor 230. The outer tube 420 is thermally coupled to the second end 232 of the heat conductor 230. Therefore, the heat generated from the heat generating device 210 can be quickly conducted to the outer tube 420. A thermal interface material layer 422 is arranged on the inner side of the outer tube 420. When the inner axle 410 is received in the outer tube 420, the thermal interface material layer 422 is between the inner axle 410 and the outer tube 420 for enhancing the thermal property therebetween. The thermal interface material layer 422 is made from thermal interface material, and for preventing the thermal interface material from becoming separated from the outer tube 420, two sealing members 424, 412 are arranged at a distal ends of the thermally conductive hinge 400.

Assembly is achieved by simply pressing the inner axle 410 into the outer tube 420. The present portable computer 100 has a simple configuration and can be assembled easily.

In operation, the heat generated from the heat generating device 210 can be partly dissipated by the main body heat dissipating module 220, and other heat can be quickly conducted and dissipated into the cover dissipating module 320 by the heat conductor 230 and the thermally conductive hinge 400. Therefore, the present portable computer has excellent thermal properties.

It is to be understood that the above-described embodiment is intended to illustrate rather than limit the invention. Variations may be made to the embodiment without departing from the spirit of the invention as claimed. The above-described embodiments are intended to illustrate the scope of the invention and not restrict the scope of the invention.

What is claimed is:

1. A portable computer comprising:
a main body having at least one heat generating device and a heat conductor having a first end thermally coupled to the at least one heat generating device and an opposite second end;
a cover having a cover heat dissipating module; and
a thermally conductive hinge rotatably coupling the cover to the main body, the thermally conductive hinge comprising an inner axle coupled to the cover and an outer tube coupled to the main body and receiving the inner axle therein, the inner axle being in thermal contact with the outer tube and being thermally coupled to the cover heat dissipating module, the outer tube being thermally coupled to the second end of the heat conductor.

2. The portable computer as claimed in claim 1, wherein the inner axle is a hollow axle with a working fluid contained therein.

3. The portable computer as claimed in claim 1, wherein the main body further comprises a main body heat dissipating module thermally mounted on the at least one heat generating device.

4. The portable computer as claimed in claim 1, wherein the thermally conductive hinge further comprises a thermal interface material layer arranged between the inner axle and the outer tube.

5. The portable computer as claimed in claim 4, wherein the thermally conductive hinge further comprises at least one sealing member arranged at a distal end of thermally conductive hinge.

6. The portable computer as claimed in claim 1, wherein the cover heat dissipating module comprises a chamber and a working fluid received therein.

7. The portable computer as claimed in claim 6, wherein the inner axle is in communication with the chamber of the cover heat dissipating module.

8. The portable computer as claimed in claim 7, wherein the cover heat dissipating module further comprises a clapboard arranged in the chamber configured for guiding the working fluid to flow into the inner axle.

9. The portable computer as claimed in claim 8, wherein the clapboard is a metallic board.

10. The portable computer as claimed in claim 1, wherein the cover is a metallic cover.

11. The portable computer as claimed in claim 10, wherein the cover is made from a material chosen from the group consisting of aluminum and an alloy of aluminum and magnesium.
